(19) United States
(12) Patent Application Publication
(10) Pub. No.: US 2026/0225761 A1
(43) Pub. Date: Aug. 6, 2026

(54) PACKAGING MEMBER

(71) Applicant: KYOCERA Document Solutions Inc., Osaka (JP)

(72) Inventor: Yu KITAMOTO, Kyoto-shi (JP)

(73) Assignee: KYOCERA Document Solutions Inc., Osaka (JP)

(21) Appl. No.: 19/457,989

(22) Filed: Jan. 23, 2026

(30) Foreign Application Priority Data
Feb. 4, 2025 (JP) 2025-016958

(51) Int. Cl. B65D 5/42; B65D 5/44

(52) U.S. Cl. CPC B65D 5/4266; B65D 5/4279; B65D 5/443

(57) ABSTRACT

A packaging member is formed by bending a single sheet material and includes a bottom plate portion, a first side wall portion, a second side wall portion, a top plate portion, and a support plate portion. The support plate portion is connected to an end of the top plate portion near the first side wall portion in a second direction and is bent from the top plate portion so as to be folded vertically downward toward the bottom plate portion, with a distal end thereof abutting against the article to be packaged. The top plate portion is bent along a first folding line. The support plate portion is bent from the top plate portion along a second folding line. The support plate portion is positioned on an inner side relative to the first side wall portion in the second direction.

### INCORPORATION BY REFERENCE

This application is based upon and claims the benefit of priority from the corresponding Japanese Patent Application No. 2025-016958, filed on February 4, 2025, the entire contents of which are hereby incorporated by reference.

### BACKGROUND

The present disclosure relates to a packaging member.

Conventionally, there has been widely used a packaging member formed by bending a single sheet material (blank) formed of a corrugated cardboard plate or the like into a prescribed three-dimensional shape. Such a packaging member is formed of a sheet material having a protrusion, a hole, a slit, a cutout, and so on formed therein. The packaging member is fabricated by bending the sheet material into a rectangular cylindrical shape and using the above-described cutout and so on in combination, thus retaining a three-dimensional shape.

An example of the packaging member described above is configured as follows. That is, this packaging member includes an upright protruding piece. The upright protruding piece is upright at a right angle with respect to a direction in which a sheet is bent. In the packaging member, a member to be packaged is pressed and secured by the upright protruding piece.

Furthermore, another example of the packaging member described above is configured as follows. That is, this packaging member has a multiplex structure composed of an outer cylindrical member and an inner cylindrical member formed of a single sheet and overlaid on each other. The outer cylindrical member includes a lid formed therein. The inner cylindrical member includes a support plate formed therein. The lid and the support plate support a member to be packaged by abutting against an outer surface of the member to be packaged. Having such a multiplex structure, the packaging member is configured to allow the lid and the support plate to be formed out of the single sheet.

### SUMMARY

A packaging member according to an aspect of the present disclosure is formed by bending a single sheet material and houses inside an article to be packaged. The packaging member includes a bottom plate portion, a first side wall portion, a second side wall portion, a top plate portion, and a support plate portion. The bottom plate portion has a rectangular shape. The first side wall portion is connected to one end of the bottom plate portion in a second direction and is folded substantially vertically upward from the bottom plate portion. The second side wall portion is connected to the other end of the bottom plate portion in the second direction and is folded substantially vertically upward from the bottom plate portion so as to be opposed to the first side wall portion in the second direction. The top plate portion is connected to an end of the first side wall portion opposite to the bottom plate portion and is bent from the first side wall portion, with a distal end thereof stretched to the second side wall portion so that the top plate portion is parallel to the bottom plate portion. The support plate portion is connected to an end of the top plate portion near the first side wall portion in the second direction and is bent from the top plate portion so as to be folded substantially vertically downward toward the bottom plate portion, with a distal end thereof directed from the top plate portion toward the bottom plate portion abutting against the article to be packaged. The top plate portion is bent from the first side wall portion along a first folding line formed between the first side wall portion and the top plate portion so as to be parallel to the bottom plate portion and orthogonal to the second direction. The support plate portion is bent from the top plate portion along a second folding line formed at a position between the support plate portion and the top plate portion nearer to the second side wall portion than the first folding line in the second direction so as to be parallel to the first folding line. The support plate portion is positioned on an inner side relative to the first side wall portion in the second direction.

### BRIEF DESCRIPTION OF THE DRAWINGS

FIG. 1 is a perspective view of a packaging member according to an embodiment.

FIG. 2 is a plan view, as seen sideways, of the packaging member shown in FIG. 1.

FIG. 3 is a developed view of the packaging member.

FIG. 4 is a sectional view of the packaging member cut at a middle part thereof in a first direction so as to be parallel to a second direction and a top-bottom direction.

### DETAILED DESCRIPTION

With reference to the appended drawings, the following describes an embodiment of the present disclosure. The present disclosure, however, is not limited to what is described below. In the description, a direction indicated by a double-headed arrow D1 in the drawings corresponds to a “first direction” (a longitudinal direction of a packaging member 1), and a direction indicated by a double-headed arrow D2 in the drawings corresponds to a “second direction” (a transverse direction of the packaging member 1). The first direction D1 and the second direction D2 are orthogonal to each other.

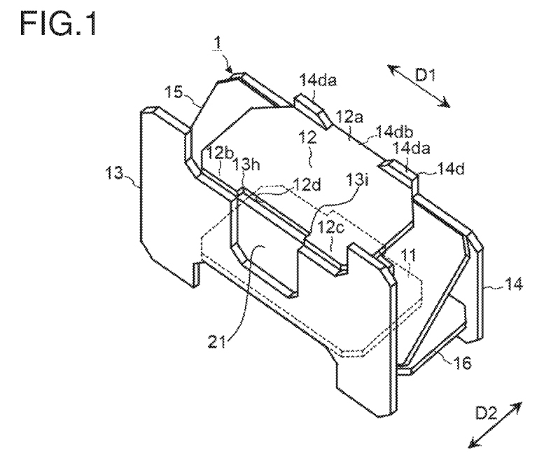

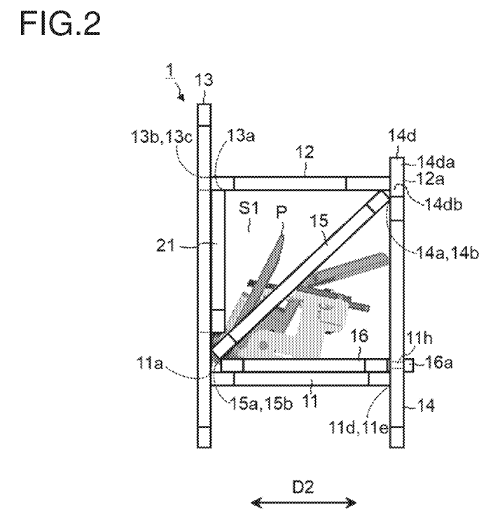

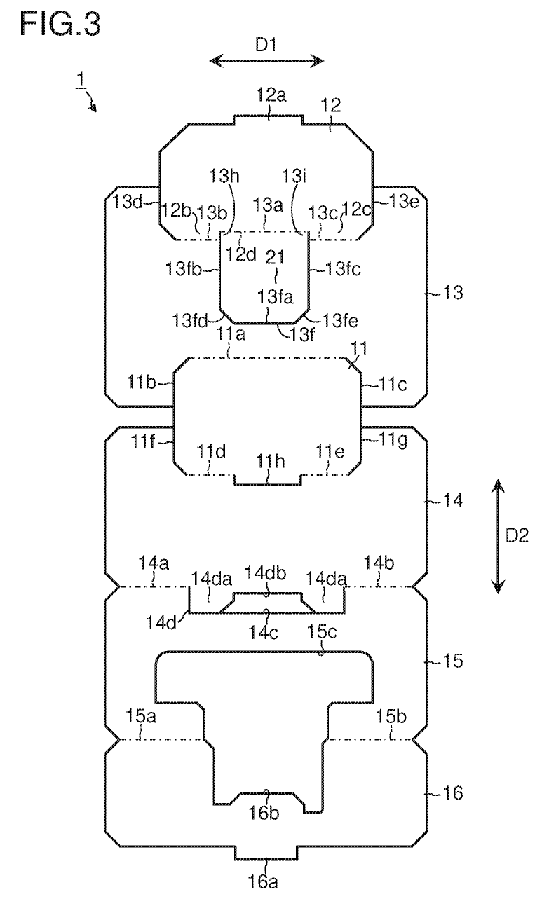

FIG. 1 is a perspective view of the packaging member 1 according to the embodiment. FIG. 2 is a plan view, as seen sideways, of the packaging member 1 shown in FIG. 1. FIG. 3 is a developed view of the packaging member 1.

As shown in FIG. 1 and FIG. 2, the packaging member 1 in an assembled state is a rectangular cylindrical member having substantially a rectangular parallelepiped outer shape. In the following description, the packaging member 1 in the assembled state (the packaging member 1 in a state shown in FIG. 1) is referred to also as the “packaging member 1 in the assembled state.” The packaging member 1 in the assembled state is formed to be elongated in the first direction D1. The packaging member 1 includes therein a housing region S1 for housing a member P to be packaged.

When developed, the packaging member 1 is brought into a state shown in FIG. 3. In a flat developed state, the packaging member 1 is formed of a single sheet material (blank) having substantially a rectangular outer shape. In the following description, the packaging member 1 in a developed state is referred to also as the “packaging member 1 in the developed state.”

Examples of the sheet material used to form the packaging member 1 include corrugated cardboard made of paper, polypropylene corrugated cardboard (= plastic corrugated cardboard), and a polyethylene terephthalate (PET) film. That is, the packaging member 1 is formed by bending such a single sheet material.

### 1. Regarding Packaging Member 1 in Assembled State

First, with reference to FIG. 1 and FIG. 2, a description is given of the packaging member 1 in the assembled state. Unless otherwise specified, the packaging member 1 described herein refers to the packaging member 1 in the assembled state.

As shown in FIG. 1 and FIG. 2, the packaging member 1 includes a bottom plate portion 11, a top plate portion 12, a first side wall portion 13, a support plate portion 21, a second side wall portion 14, a reinforcing plate portion 15, and an intermediate bottom portion 16.

The bottom plate portion 11 is arranged at a lower end (a bottom surface) of the packaging member 1. When seen planarly in a top-bottom direction, the bottom plate portion 11 has substantially a rectangular shape. The bottom plate portion 11 is parallel to the second direction D1.

In the second direction D2, the first side wall portion 13 is connected to one end of the bottom plate portion 11 (a left end thereof in FIG. 2). The first side wall portion 13 is folded upward from the one end of the bottom plate portion 11 so as to be vertical to the bottom plate portion 11.

In the second direction D2, the second side wall portion 14 is connected to the other end of the bottom plate portion 11 (a right end thereof in FIG. 2). The second side wall portion 14 is folded upward from the other end of the bottom plate portion 11 so as to be vertical to the bottom plate portion 11. The second side wall portion 14 is opposed to the first side wall portion 13 in the second direction D2 with the reinforcing plate portion 15 and the member P to be packaged interposed therebetween.

The top plate portion 12 is arranged at an upper end (a top surface) of the packaging member 1. When seen planarly in the top-bottom direction, the top plate portion 12 has substantially a rectangular shape extending in the first direction D1. The top plate portion 12 is opposed to the bottom plate portion 11 in the top-bottom direction with the reinforcing plate portion 15 and the intermediate bottom portion 16 interposed therebetween.

The top plate portion 12 is connected to an upper end of the first side wall portion 13. The top plate portion 12 extends from the upper end of the first side wall portion 13 toward the second side wall portion 14 so as to be parallel to the second direction D2. A distal end of the top plate portion 12 is stretched in a bridging manner to an upper end of the second side wall portion 14. The top plate portion 12 is substantially vertical to each of the first side wall portion 13 and the second side wall portion 14.

The top plate portion 12 includes an insertion piece 12a. The insertion piece 12a protrudes in the second direction D2 from a middle part of the top plate portion 12. The insertion piece 12a is inserted into an engagement section 14d (more specifically, a concave part 14db) formed in the second side wall portion 14. The top plate portion 12 engages with the second side wall portion 14 by means of the insertion piece 12a and the engagement section 14d.

The support plate portion 21 is connected to an end of the top plate portion 12 opposite to the second side wall portion 14. The support plate portion 21 extends downward from the top plate portion 12. The support plate portion 21 is parallel to the first side wall portion 13. In the second direction D2, the support plate portion 21 is positioned on an inner side (nearer to the second side wall portion 14) relative to the first side wall portion 13. A distal end of the support plate portion 21 abuts against an outer surface of the member P to be packaged.

The reinforcing plate portion 15 is connected to an upper end of the second side wall portion 14. The reinforcing plate portion 15 extends obliquely downward from the upper end of the second side wall portion 14 so as to be closer to the first side wall portion 13. At a position below a lower end of the support plate portion 21, a distal end of the reinforcing plate portion 15 is in contact with an inner surface of the first side wall portion 13.

The intermediate bottom portion 16 is connected to a distal end of the reinforcing plate portion 15. The intermediate bottom portion 16 extends from the distal end of the reinforcing plate portion 15 toward the second side wall portion 14 so as to be parallel to the second direction D2. In the top-bottom direction, the intermediate bottom portion 16 is stacked on an upper surface of the bottom plate portion 11. That is, the bottom plate portion 11 and the intermediate bottom portion 16 overlap with each other in two tiers in the top-bottom direction.

The intermediate bottom portion 16 includes an insertion piece 16a. The insertion piece 16a protrudes in the second direction D2 from a middle part of the intermediate bottom portion 16. The insertion piece 16a is inserted into a cut 11h formed between the bottom plate portion 11 and the second side wall portion 14. This engages the intermediate bottom portion 16 with the second side wall portion 14.

The packaging member 1 includes the housing region S1. The housing region S1 is defined to be surrounded by the bottom plate portion 11, the intermediate bottom portion 16, and the top plate portion 12 in the top-bottom direction and by the first side wall portion 13, the support plate portion 21, and the second side wall portion 14 in the second direction D2. Furthermore, the housing region S1 is open at both ends thereof in the first direction D1 and communicates with a space external to the packaging member 1. The member P to be packaged is housed in the housing region S1.

The reinforcing plate portion 15 extends diagonally from an upper side to a lower side in the housing region S1, thereby providing reinforcement so that the thus defined housing region S1 is prevented from collapsing. That is, a base of the reinforcing plate portion 15 is connected to the upper end of the second side wall portion 14, and the distal end of the reinforcing plate portion 15 is in contact with the first side wall portion 13 and the intermediate bottom portion 16. Thus, when an excessive load acts on the packaging member 1 in the second direction D2, the reinforcing plate portion 15 exerts a reinforcing effect between the first side wall portion 13 and the second side wall portion 14. Furthermore, when a load acts on the packaging member 1 in the top-bottom direction, the reinforcing plate portion 15 exerts a reinforcing effect between the top plate portion 12 and the bottom plate portion 11.

### 2. Regarding Packaging Member 1 in Developed State

Next, with reference principally to FIG. 3, a description is given of the packaging member 1 in the developed state. Unless otherwise specified, the packaging member 1 described herein refers to the packaging member 1 in the developed state. Furthermore, one side in the second direction D2 corresponding to an upper side shown in FIG. 3 is referred to as an “upper side in the second direction D2.” Furthermore, the other side in the second direction D2 corresponding to a lower side shown in FIG. 3 is referred to as a “lower side in the second direction D2.”

In the packaging member 1, from the upper side in the second direction D2, the top plate portion 12, the first side wall portion 13, the bottom plate portion 11, the second side wall portion 14, the reinforcing plate portion 15, and the intermediate bottom portion 16 are formed to be arranged in this order.

When seen planarly in the top-bottom direction (a direction vertical to a drawing plane of FIG. 3), the top plate portion 12 has substantially a rectangular shape. As described above, the top plate portion 12 includes the insertion piece 12a. The insertion piece 12a is positioned at a middle of the first side wall portion 13 in the first direction D1. The insertion piece 12a protrudes upward in the second direction D2 from the middle part of the top plate portion 12.

Each of the support plate portion 21 and the first side wall portion 13 is connected to a lower end of the top plate portion 12. A folding line 13a (a second folding line) is formed between the top plate portion 12 and the support plate portion 21. Folding lines 13b and 13c (first folding lines) and cuts 13d and 13e are formed between the first side wall portion 13 and the top plate portion 12. A cut 13f is formed between each of the top plate portion 12 and the first side wall portion 13 and the support plate portion 21.

The folding lines 13a to 13c are parallel to the first direction D1. The folding line 13a is positioned between the folding lines 13b and 13c in the first direction D1. More specifically, the folding lines 13a and 13b are adjacent to each other in the first direction D1 with the cut 13f (more specifically, an after-mentioned vertical part 13fb) interposed therebetween. The folding lines 13a and 13c are adjacent to each other in the first direction D1 with the cut 13f (more specifically, an after-mentioned vertical part 13fc) interposed therebetween. The folding lines 13b and 13c are arranged linearly with respect to each other along the first direction D1. The folding line 13a is positioned on an upper side relative to the folding lines 13b and 13c in the second direction D2.

In other words, the folding line 13a is adjacent to the folding line 13b with the vertical part 13fb interposed therebetween in the first direction D1 and is displaced upward relative to the folding line 13b in the second direction D2. Thus, a step 13h (a step gap) is formed between the folding lines 13a and 13b. Furthermore, the folding line 13a is adjacent to the folding line 13c with the vertical part 13fc interposed therebetween in the first direction D1 and is displaced upward relative to the folding line 13c in the second direction D2. Thus, a step 13i (a step gap) is formed between the folding lines 13a and the 13c.

The top plate portion 12 includes convex parts 12b and 12c and a concave part 12d. The convex parts 12b and 12c are formed on both outer sides of the folding line 13a in the first direction D1. The concave part 12d is formed between the convex parts 12b and 12c in the first direction D1.

The convex parts 12b and 12c protrude downward in the second direction D2 from the middle part of the top plate portion 12. The concave part 12d, on the other hand, is recessed upward from the convex parts 12b and 12c in the second direction D2.

The step 13h is formed between the convex part 12b and the concave part 12d. Furthermore, the step 13i is formed between the convex part 12c and the concave part 12d. The folding line 13a extends along a bottom of the concave part 12d. The folding line 13b extends along a distal end of the convex part 12b. The folding line 13c extends along a distal end of the convex part 12c.

The cuts 13d and 13e extend downward in the second direction D2 from angles formed between the first side wall portion 13 and the top plate portion 12. Each of the cuts 13d and 13e is composed of a straight line part extending downward (toward the bottom plate portion 11) parallel to the second direction D2 and an inclined part extending downward, from a distal end of the straight line part, obliquely with respect to the second direction D2 so as to be closer to the middle of the first side wall portion 13 in the first direction D1. A distal end of the inclined part of the cut 13d is positioned at one end of the folding line 13b in the first direction D1. A distal end of the inclined part of the cut 13e is positioned at one end of the folding line 13c in the first direction D1.

The support plate portion 21 has been partially cut out from the top plate portion 12 and the first side wall portion 13 along the cut 13f. The cut 13f includes a horizontal part 13fa, the vertical parts 13fb and 13fc, and tapered parts 13fd and 13fe.

The horizontal part 13fa is a straight line-shaped cut parallel to the first direction D1. The tapered part 13fd extends obliquely upward in the second direction D2 from one end of the horizontal part 13fa in the first direction D1. The tapered part 13fe extends obliquely upward in the second direction D2 from the other end of the horizontal part 13fa in the first direction D1. The vertical part 13fb extends upward in the second direction D2 from an end of the tapered part 13fd opposite to the horizontal part 13fa so as to be parallel to the second direction D2. The vertical part 13fc extends upward in the second direction D2 from an end of the tapered part 13fe opposite to the horizontal part 13fa so as to be parallel to the second direction D2.

When seen planarly in the top-bottom direction, the bottom plate portion 11 has substantially a rectangular shape elongated in the first direction D1. The bottom plate portion 11 is connected to a lower end of the first side wall portion 13. Furthermore, the bottom plate portion 11 is connected to the upper end of the second side wall portion 14.

A folding line 11a and cuts 11b and 11c are formed between the bottom plate portion 11 and the first side wall portion 13. Furthermore, folding lines 11d and 11e and cuts 11f, 11g, and 11h are formed between the bottom plate portion 11 and the second side wall portion 14.

The folding line 11a is parallel to the first direction D1. The folding line 11a is positioned at an upper end of the bottom plate portion 11.

The cuts 11b and 11c extend upward in the second direction D2 from angles formed between the bottom plate portion 11 and the first side wall portion 13. Each of the cuts 11b and 11c is composed of a straight line part extending upward from a corresponding one of the angles formed between the bottom plate portion 11 and the first side wall portion 13 so as to be parallel to the second direction D2 and an inclined part extending upward, from a distal end of the straight line part, obliquely with respect to the second direction D2 so as to be closer to a middle of the bottom plate portion 11 in the first direction D1. A distal end of the inclined part of the cut 11b is positioned at one end of the folding line 11a. A distal end of the inclined part of the cut 11c is positioned at the other end of the folding line 11a.

The folding lines 11d and 11e are positioned at a lower end of the bottom plate portion 11. The folding lines 11d and 11e are arranged linearly with respect to each other along the first direction D1.

The cuts 11f and 11g extend downward in the second direction D2 from angles formed between the bottom plate portion 11 and the second side wall portion 14. Each of the cuts 11f and 11g is composed of a straight line part extending downward parallel to the second direction D2 and an inclined part extending downward, from a distal end of the straight line part, obliquely with respect to the second direction D2 so as to be closer to the middle of the bottom plate portion 11 in the first direction D1. A distal end of the inclined part of the cut 11f is positioned at one end of the folding line 11d. A distal end of the inclined part of the cut 11g is positioned at one end of the folding line 11e.

The cut 11h is composed of a straight line-shaped part parallel to the first direction D1 and straight line-shaped parts extending upward from both ends of this part so as to be parallel to the second direction D2.

When seen planarly in the top-bottom direction (the direction vertical to the drawing plane shown in FIG. 3), the second side wall portion 14 has substantially a rectangular shape. The second side wall portion 14 is connected to the lower end of the bottom plate portion 11. Folding lines 14a and 14b and a cut 14c are formed between the reinforcing plate portion 15 and the second side wall portion 14. Furthermore, the second side wall portion 14 includes the engagement section 14d.

The folding lines 14a and 14b are parallel to the first direction D1. The folding lines 14a and 14b are arranged linearly along the first direction D1. The cut 14c is composed of a straight line part parallel to the first direction D1 and parts extending upward from both ends of the straight line part so as to be parallel to the second direction D2.

The engagement section 14d protrudes downward from a middle part of the second side wall portion 14. The engagement section 14d is positioned at a middle of the second side wall portion 14 in the first direction D1. The engagement section 14d includes a pair of convex parts 14da and the concave part 14db. The convex parts 14da as the pair are formed at both ends of the engagement section 14d in the first direction D1. The convex parts 14da protrude downward in the second direction D2. The concave part 14db is formed between the convex parts 14da. The concave part 14db is recessed upward from protruding ends of the convex parts 14da in the second direction D2.

When seen planarly in the top-bottom direction (the direction vertical to the drawing plane shown in FIG. 3), the reinforcing plate portion 15 has substantially a rectangular shape (specifically, a C shape). The reinforcing plate portion 15 is connected to a lower end of the second side wall portion 14. Folding lines 15a and 15b are formed between the reinforcing plate portion 15 and the intermediate bottom portion 16. Furthermore, a support concave part 15c is formed in the reinforcing plate portion 15.

The folding lines 15a and 15b are parallel to the first direction D1. The folding lines 15a and 15b are arranged linearly along the first direction D1. The support concave part 15c is formed at substantially a middle part of the reinforcing plate portion 15. The support concave part 15c is formed to be recessed upward from a lower end of the reinforcing plate portion 15 in the second direction D2. The support concave part 15c has a shape conforming to an outer shape of the member P to be packaged.

The intermediate bottom portion 16 is connected to the lower end of the reinforcing plate portion 15. When seen planarly in the top-bottom direction, the intermediate bottom portion 16 has substantially a rectangular shape (specifically, a C shape). The intermediate bottom portion 16 includes the insertion piece 16a and a support concave part 16b.

The insertion piece 16a is positioned at a middle of the intermediate bottom portion 16 in the first direction D1. The insertion piece 16a protrudes downward from the middle part of the intermediate bottom portion 16. The support concave part 16b is formed at the middle part of the intermediate bottom portion 16 in the first direction D1. The support concave part 16b is formed to be recessed downward from an upper end of the intermediate bottom portion 16. The support concave part 16b is formed to be continuous from a lower end of the support concave part 15c. That is, the support concave part 15c and the support concave part 16b constitute a rectangular opening formed by tearing off along a single continuous tear-off line. The support concave part 16b has a shape conforming to the outer shape of the member P to be packaged.

### 3. Regarding How to Assemble Packaging Member 1 in Developed State

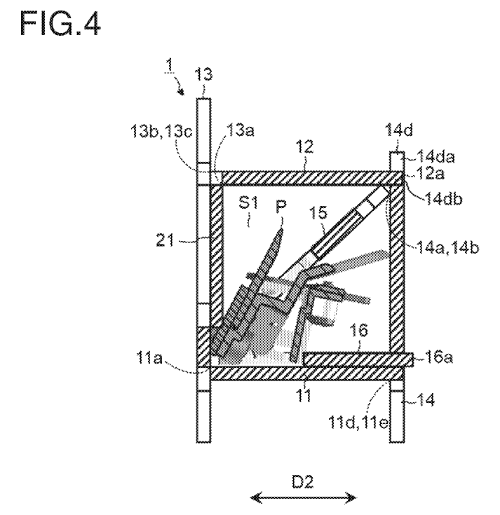

Next, a description is given of how to assemble the packaging member 1 in the developed state. FIG. 4 is a sectional view of the packaging member 1 cut at a middle part thereof in the first direction D1 so as to be parallel to the second direction D2 and the top-bottom direction.

The first side wall portion 13 is bent in a valley fold direction in FIG. 3 along the folding line 11a. The second side wall portion 14 is bent in the valley fold direction in FIG. 3 along the folding lines 11d and 11e. Thus, as shown in FIGS. 1 and 4, the first side wall portion 13 and the second side wall portion 14 become vertically upright from the bottom plate portion 11.

The top plate portion 12 is bent in the valley fold direction in FIG. 3 along the folding lines 13b and 13c. Further, the insertion piece 12a is inserted into the engagement section 14d (more specifically, the concave part 14db) of the second side wall portion 14 in an upright state. Thus, as shown in FIGS. 1 and 4, the top plate portion 12 becomes vertically upright from the first side wall portion 13 and engages with the second side wall portion 14.

The support plate portion 21 is bent in the valley fold direction in FIG. 3 along the folding line 13a. Thus, as shown in FIGS. 1 and 4, the support plate portion 21 droops from the top plate portion 12. At this time, in a state where the first side wall portion 13 is upright from the bottom plate portion 11, the support plate portion 21 is positioned on an inner side in the housing region S1 relative to the first side wall portion 13 in the second direction D2. Further, a distal end of the support plate portion 21 is made to abut against the outer surface of the member P to be packaged.

The reinforcing plate portion 15 is bent in the valley fold direction in FIG. 3 along the folding lines 14a and 14b. At this time, a distal end (the folding lines 15a and 15b) of the reinforcing plate portion 15 is made to abut against the first side wall portion 13. Furthermore, an inner surface of the support concave part 15c is made to abut against the outer surface of the member P to be packaged (see FIGS. 1 and 4). At least the distal end of the support plate portion 21 and the inner surface of the support concave part 15c abut against the outer surface of the member P to be packaged, and thus the member P to be packaged is secured and supported to the packaging member 1.

The intermediate bottom portion 16 is bent in a mountain fold direction in FIG. 3 along the folding lines 15a and 15b. Further, the insertion piece 16a is inserted into the cut 11h. Thus, in a state of overlapping with the bottom plate portion 11 in the top-bottom direction, the intermediate bottom portion 16 engages with the second side wall portion 14.

As described above, the distal end of the support plate portion 21 abuts against the outer surface of the member P to be packaged in the top-bottom direction. As a result, the member P to be packaged is pressed downward and supported in that state by the support plate portion 21. Thus, the member P to be packaged is secured and supported by the packaging member 1 while being protected by a more favorable cushioning effect in the top-bottom direction.

Further, as described above, the folding line 13a is positioned nearer to the housing region S1 (on an upper side in FIG. 3 and nearer to the second side wall portion 14 in FIG. 1) than the folding lines 13b and 13c in the second direction D2. Moreover, the vertical part 13fb is formed between the folding line 13a and the folding line 13b, and the vertical part 13fc is formed between the folding line 13a and the folding line 13c. With this configuration, when the support plate portion 21 is bent along the folding line 13a, the steps 13h and 13i are formed, so that the support plate portion 21 is positioned on an inner side relative to the first side wall portion 13 in the second direction D2.

Thus, the distal end of the support plate portion 21 can be made to abut from above the member P to be packaged against the outer surface of the member P to be packaged so as to press down the member P to be packaged. Further, the thus configured support plate portion 21 can be formed of a single sheet material used to form the packaging member 1. Accordingly, it is possible to form the support plate portion 21 without requiring that the packaging member 1 have a multiplex structure or that another packaging member separate from the packaging member 1 be used. It is, therefore, possible to suppress complication of the shape of the sheet material used to form the packaging member 1 and deterioration of efficiency in assembling the packaging member 1.

While the foregoing has described the embodiment of the present disclosure, the present disclosure is not limited in scope thereto and can be implemented by adding various modifications thereto without departing from the spirit of the disclosure.

What is claimed is:

1. A packaging member that is formed by bending a single sheet material and houses inside an article to be packaged, the packaging member comprising:
a bottom plate portion having a rectangular shape;
a first side wall portion that is connected to one end of the bottom plate portion in a second direction and is folded substantially vertically upward from the bottom plate portion;
a second side wall portion that is connected to another end of the bottom plate portion in the second direction and is folded substantially vertically upward from the bottom plate portion so as to be opposed to the first side wall portion in the second direction;
a top plate portion that is connected to an end of the first side wall portion opposite to the bottom plate portion and is bent from the first side wall portion, with a distal end thereof stretched to the second side wall portion so that the top plate portion is parallel to the bottom plate portion; and
a support plate portion that is connected to an end of the top plate portion near the first side wall portion in the second direction and is bent from the top plate portion so as to be folded substantially vertically downward toward the bottom plate portion, with a distal end thereof directed from the top plate portion toward the bottom plate portion abutting against the article to be packaged,
wherein
the top plate portion is bent from the first side wall portion along a first folding line formed between the first side wall portion and the top plate portion so as to be parallel to the bottom plate portion and orthogonal to the second direction,
the support plate portion is bent from the top plate portion along a second folding line formed at a position between the support plate portion and the top plate portion nearer to the second side wall portion than the first folding line in the second direction so as to be parallel to the first folding line, and
the support plate portion is positioned on an inner side relative to the first side wall portion in the second direction.

2. The packaging member according to claim 1, wherein
the top plate portion includes:
a concave part that is formed at an end thereof near the first side wall portion in the second direction and is recessed toward the second side wall portion along the second direction;
a pair of convex parts that is formed at the end thereof near the first side wall portion in the second direction and protrudes from both ends of the concave part toward the first side wall portion in the second direction; and
a step that is connected to the concave part and each of the pair of convex parts and extends between the each of the pair of convex parts and the concave part along the second direction,
wherein the first folding line extends along respective distal ends of the pair of convex parts, and
the second folding line extends along a bottom of the concave part.

3. The packaging member according to claim 1, wherein
a pair of the first folding lines is formed at both ends of the second folding line, and
each of the pair of the first folding lines is connected to the second folding line via a step gap in the second direction.

4. The packaging member according to claim 1, wherein
the sheet material is made of resin.
